(19) United States
(12) Patent Application Publication
(10) Pub. No.: US 2017/0131827 A1
(43) Pub. Date: May 11, 2017

(54) ARRAY SUBSTRATE, METHOD FOR MANUFACTURING THE SAME, AND TOUCH DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Xun PU, Beijing (CN); Hongmin LI, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/276,988

(22) Filed: Sep. 27, 2016

(30) Foreign Application Priority Data
Nov. 9, 2015 (CN) 201510754151.0

(51) Int. Cl. G06F 3/041; G06F 3/044

(52) U.S. Cl. CPC G06F 3/0416; G06F 3/0412; G06F 3/044; G06F 2203/04103

(57) ABSTRACT

The present disclosure provides an array substrate, a method for manufacturing the same, and a touch display device. The array substrate includes a base substrate and first metal signal lines and first touch electrodes arranged on the base substrate. The first touch electrode is made of metal, and the first touch electrodes are arranged at a layer different from the first metal signal lines and are insulated with the first metal signal lines.

### CROSS-REFERENCE TO RELATED APPLICATIONS

This application claims priority to Chinese application No. 201510754151.0, filed Nov. 9, 2015, which is hereby incorporated by reference in its entirety.

### TECHNICAL FIELD

The present disclosure relates to the field of the display technology, in particular to an array substrate, a method for manufacturing the same and a touch display device.

### BACKGROUND

In the related art, the touch electrodes of an In_cell touch screen are formed by segmenting an indium tin oxide (ITO) electrode on an array substrate, and each of the touch electrodes is connected to a flexible printed circuit (FPC) through a metal connection line. However, since an ITO material has a relatively large resistance, a delay of touch signal transmission may occur, and the touch effect of a touch screen may be influenced adversely.

### SUMMARY

In view of this, the present disclosure provides an array substrate, a method for manufacturing the same and a touch display device, so as to solve the adverse influence on the touch effect of a touch screen caused by the delay of the touch signal transmission due to the relatively large resistance of the touch electrode made of ITO in the related art.

To achieve the objective hereinabove, the present disclosure provides an array substrate, which includes a base substrate and first metal signal lines and first touch electrodes arranged on the base substrate, wherein the first touch electrodes are made of metal and the first touch electrodes are arranged at a layer different from the first metal signal lines and are insulated with the first metal signal lines.

Alternatively, the first touch electrodes are parallel to the first metal signal lines, and each of the first touch electrodes is close to a corresponding first metal signal line.

Alternatively, an orthographic projection of each of the first touch electrodes onto the base substrate is not overlapped with an orthographic projection of the corresponding first metal signal line onto the base substrate.

Alternatively, an edge of each of the first touch electrodes is aligned with an edge of an adjacent first metal signal line along an extending direction of the first touch electrode.

Alternatively, each of the first touch electrodes and the corresponding first metal signal line are spaced from each other by a predetermined interval along a direction perpendicular to an extending direction of the first touch electrode.

Alternatively, the predetermined interval is 1 μm.

Alternatively, the first metal signal line includes gate lines, and the array substrate further includes a first gate insulation layer, arranged on the gate line; a second gate insulation layer, arranged on the first touch electrode. The first touch electrodes are arranged between the first gate insulation layer and the second gate insulation layer.

Alternatively, each of the first touch electrodes includes a plurality of electrode wires, and the electrode wires in one first touch electrode are adjacent to and are connected to each other.

Alternatively, each of the first touch electrodes is a drive electrode or an induction electrode.

Alternatively, the array substrate further includes second metal signal lines and second touch electrodes, where the first metal signal lines are gate lines, the second metal signal lines are data lines, and the second touch electrodes are arranged at a layer and made of a material identical to the data lines.

Alternatively, each of the second touch electrodes includes a plurality of electrode wires, and the electrode wires in one second touch electrode are adjacent to and connected to each other.

A touch display device is further provided by the present disclosure, which includes the above array substrate.

A method of manufacturing an array substrate is further provided by the present disclosure, which includes the following steps: providing a base substrate; and forming, on the base substrate, first metal signal lines and first touch electrodes. The first touch electrodes are made of metal, and the first touch electrodes are arranged at a layer different from the first metal signal lines and are insulated with the first metal signal lines.

Alternatively, when the first metal signal line are gate lines, and the method of manufacturing an array substrate further includes the following steps: forming, on the base substrate, a pattern of a gate metal layer including a pattern of gate lines; forming a first gate insulation layer; forming a pattern of the first touch electrodes, where the first touch electrodes are parallel to the first metal signal lines, and each of the first touch electrodes is close to a corresponding first metal signal line; forming a second gate insulation layer; forming a pattern of an active layer; and forming a pattern of a source-drain metal layer, wherein the pattern of the source-drain metal layer includes patterns of data lines, source electrodes, drain electrodes and second touch electrodes.

According to the technical solution of the present disclosure, the first touch electrodes are made of metal and have a small resistance, thereby solving the delay of the touch signal transmission due to the relatively large resistance of the touch electrode in the related art. In addition, the first touch electrodes are arranged at a layer different from the first metal signal lines and are insulated from the first metal signal lines, so that the first touch electrodes may not be shorted to the first metal signal lines even though they are very close to each other, since they are not arranged in the same layer. Therefore, each of the first touch electrodes may be spaced from the corresponding first metal signal line by a relative small interval, thereby improving the aperture ratio.

### DESCRIPTION OF THE DRAWINGS

FIG. 1 is a schematic view showing a touch electrode of an In_cell touch screen in the related art;

FIG. 2 is a schematic view showing a working principle of an In_cell touch screen in the related art;

FIG. 3 is a schematic view showing an array substrate in some embodiments of the present disclosure;

FIG. 4 is a schematic view showing an array substrate in some embodiments of the present disclosure;

FIG. 5 is a schematic view showing an array substrate in some embodiments of the present disclosure;

FIG. 6 is a schematic view showing an array substrate in some embodiments of the present disclosure; and

FIG. 7 is a schematic view showing an array substrate in some embodiments of the present disclosure.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

The present disclosure will be described in detail hereinafter in conjunction with the drawings and embodiments. The following embodiments are for illustrative purposes only, but shall not be used to limit the scope of the present disclosure.

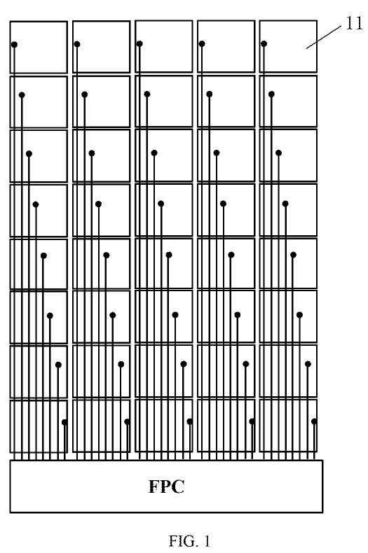

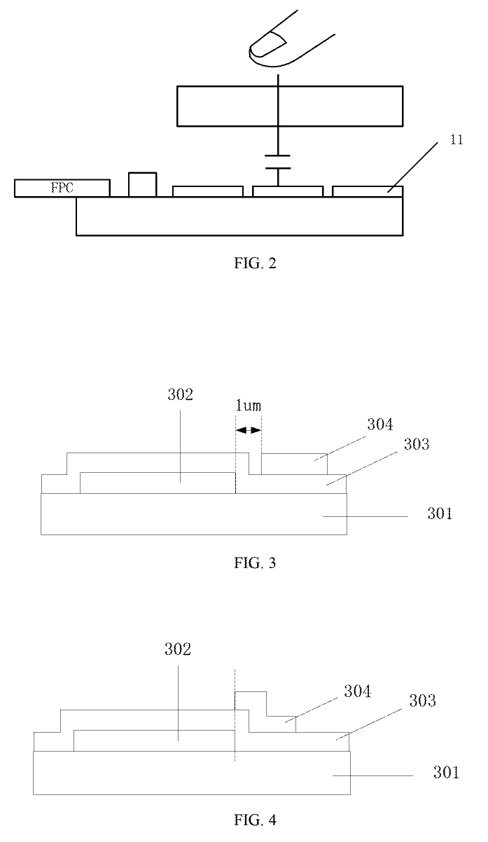

FIG. 1 is a schematic view showing a touch electrode of an In_cell touch screen in the related art. The touch electrodes 11 are formed by segmenting an ITO electrode on an array substrate, and each touch electrode 11 (i.e. a small rectangular electrode in the FIG. 1) is connected to an flexible printed circuit (FPC) through a metal connection line. Referring to FIG. 2, when a touch screen is working, a capacitance of the corresponding touch electrode 11 may be changed due to a touch, and then a position of a touch point can be determined according to the change of the capacitance.

However, since the ITO material has a relatively large resistance, a delay of the touch signal transmission may occur, and the touch effect of the touch screen may be influenced adversely.

In order to solve the adverse influence on the touch effect of the touch screen caused by the delay of the touch signal transmission due to the relatively large resistance of the touch electrode made of ITO, an array substrate is provided by the present disclosure, which includes a base substrate and first metal signal lines and first touch electrodes arranged on the base substrate. The first touch electrodes are made of metal, and the first touch electrodes are arranged at a layer different from the first metal signal lines and are insulated with the first metal signal lines.

According to the technical solution of the present disclosure, the first touch electrodes are made of metal and thus have a smaller resistance than the touch electrodes made of the ITO in the related art, thereby solving the delay of the touch signal transmission due to the relatively large resistance of the touch electrode.

Of course, the aperture ratio should be taken into consideration when the touch electrodes are made of metal. To be specific, if the first control electrodes are arranged at a layer identical to the first metal signal lines on the array substrate, only when a distance between the first control electrode and the first metal signal line is at least greater than 3.5 μm, the short circuit there between may not occur, and the capacitance there between may not be too large due to a limited process condition. However, it means that the aperture ratio will be reduced. Therefore, in some embodiments of the present disclosure, the first touch electrodes are provided at a layer different from the first metal signal lines, and the first touch electrodes may not be shorted to the first metal signal lines even though they are very close to each other, since they are not arranged in the same layer. Therefore, each of the first touch electrodes may be spaced from the corresponding first metal signal line by a relative small interval. For example, the interval may be smaller than 3.5 μm, so as to improve the aperture ratio.

Alternatively, the first touch electrodes are parallel to the first metal signal lines, and each of the first touch electrodes is close to a corresponding first metal signal line, thereby improving the aperture ratio. For example, the interval between each of the first touch electrodes and the corresponding first metal signal line may be less than or equal to 3.5 μm.

On the other hand, in terms of the capacitance, it is better not to arrange the first touch electrodes overlapped with the first metal signal lines, so as to avoid an excessively large capacitance there between and reduce loads of the first touch electrodes and the first signal lines.

FIG. 3 is a schematic view showing an array substrate in some embodiments of the present disclosure. The array substrate includes a base substrate 301, a first metal signal line 302, an insulation layer 303 and a first touch electrode 304. An orthographic projection of the first touch electrode 304 onto the base substrate 301 is not overlapped with an orthographic projection of the first metal signal line 302 onto the base substrate 301, and the first touch electrode 304 is spaced from the first metal signal line 302 by a predetermined interval in a horizontal direction. In some embodiments of the present disclosure, the interval is 1 μm, so as to avoid an excessively large capacitance there between.

FIG. 4 is a schematic view showing an array substrate in some embodiments of the present disclosure. The array substrate includes a base substrate 301, a first metal signal line 302, an insulation layer 303 and a first touch electrode 304. An orthographic projection of the first touch electrode 304 onto the base substrate 301 is not overlapped with an orthographic projection of the first metal signal line 302 onto the base substrate 301, and an edge of the first touch electrode 304 is aligned with an edge of the first metal signal line 302 adjacent to the first touch electrode 304, so as to avoid an excessively large capacitance between the first touch electrode 304 and the first metal signal line 302.

The first metal signal line may be a gate line or a data line.

In some embodiments of the present disclosure, the first metal signal line is a gate line, and the array substrate further includes a base substrate; a gate line, which is arranged on the base substrate; a first gate insulation layer, which is arranged on the gate line; a first touch electrode, which is arranged on the first gate insulation layer; and a second gate insulation layer, which is arranged on the first touch electrode.

That is, a first gate insulation layer is arranged between the first touch electrode and the gate line, and the first touch electrode is arranged at a layer different from the gate line and is insulated from the gate line, so that the interval between the first touch electrode and the gate line may be relatively small, thereby improving the aperture ratio.

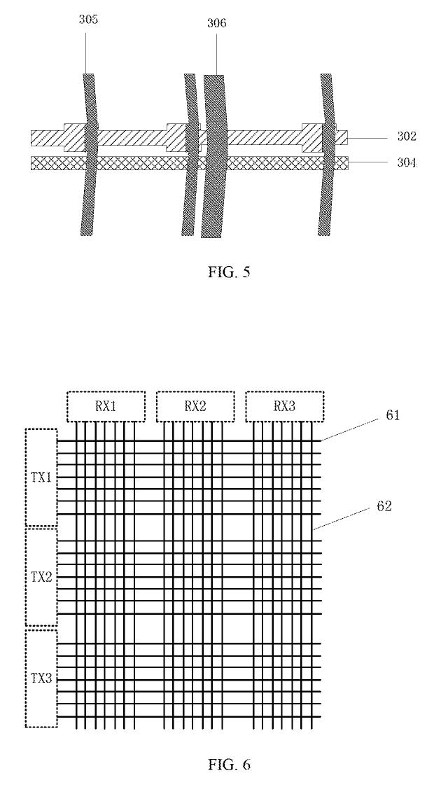

In some embodiments of the present disclosure, referring to FIG. 5, the array substrate includes a base substrate (not shown in the FIG. 5) and a gate line 302 and a first touch electrode 304 arranged on the base substrate. The first touch electrode 304 is made of metal, and first touch electrode 304 is arranged at a layer different from the first metal signal line 302 and is insulated from the first metal signal line 302. The first touch electrode 304 is parallel and close to the gate line 302.

The array substrate further includes data lines 305 and a second touch electrode 306. The second touch electrode 306 is parallel to the data lines 305 and close to a corresponding data line 305. The second touch electrode 306 is arranged at a layer and made of a material identical to the data lines 305, and second touch electrode 306 and the data lines 305 are formed in one patterning process.

Generally, a touch electrode is arranged with each gate line, a touch electrode is arranged with every three data lines. Thus, the touch electrode near the corresponding data line has a small influence on the aperture ratio. Therefore, the touch electrode and the data lines may be arranged on the same layer.

The first touch electrode in the above embodiment is embedded into the array substrate, and thus, the touch screen including the first touch electrode is an In_cell touch screen. The In_cell touch screen may be a mutual capacitance In_cell touch screen or a self capacitance In_cell touch screen.

When the touch screen specifically is the self capacitance In_cell touch screen, the touch screen only includes the first touch electrode. When the touch screen specifically is a mutual capacitance In_cell touch screen, the touch screen further includes the second touch electrode, where the second touch electrode may be arranged on the array substrate together with the first touch electrode, or may be provided on a substrate opposite to the array substrate. The first touch electrode may be a drive electrode or an induction electrode. When the first touch electrode is a drive electrode, the first touch electrode is an induction electrode. When the first touch electrode is an induction electrode, the second touch electrode is a drive electrode.

It should be understood that, a width of the metal wire as the touch electrode may not be too large to adversely influence the aperture ratio. However, since a single metal wire is too narrow to be a touch electrode, the touch electrodes needs to be formed by a plurality of metal lines connected to each other. That is, alternatively, each first touch electrode includes a plurality of electrode wires, and the electrode wires in one first touch electrode are adjacent to and connected to each other.

In some embodiments of the present disclosure, the array substrate further includes a second touch electrode. Similarly, the second touch electrode includes a plurality of electrode wires, and the electrode wires in one second touch electrode are adjacent to and connected to each other.

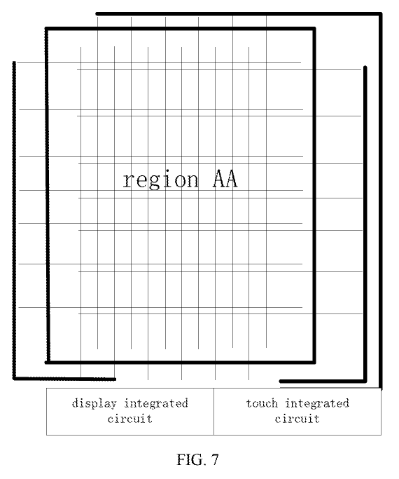

FIG. 6 is a schematic view showing an array substrate in some embodiments of the present disclosure. The array substrate includes a plurality of first touch electrodes (TX1, TX2, TX3 . . . ) and a plurality of second touch electrodes (RX1, RX2, RX3). Each first touch electrode includes seven electrode wires 61, and the electrode wires 61 in one first touch electrode are adjacent to and connected to each other. Each second touch electrode includes seven electrode wires 62, and the electrode wires 62 in one second touch electrode are adjacent to and connected to each other.

The fundamental principle of grouping the electrode wires is as follows: determining the total number of the touch electrodes required for the whole screen, and averagely assigning all the electrode wires into each of the groups so as to ensure that the electrodes included in each group are basically consistent.

For example, a certain display screen includes 740 gate lines and 1140 data lines, each gate line corresponds to a TX wire, and each data line corresponds to a RX wire. That is, the display screen includes 740 TX wires and 1140/3=380 RX wires. It is assumed that the display screen includes 12 TX electrodes and 10 RX electrodes, i.e. each TX electrode includes 740/12=61 TX wires (each of the last several groups may include 62 TX wires), and then, each RX electrode will include 380/10=38 RX wires.

Referring to FIG. 7, in the periphery the display region (region AA) of the array substrate, the signal lines (i.e., the gate lines and the data lines) may be pulled out from two side (e.g., the left side and the lower side) of the display region to a display integrated circuit, and the touch electrodes (i.e., the TX electrodes and the RX electrodes) may be pulled out from the other two sides (e.g., the upper side and the right side) of the display region to a touch integrated circuit, so that the leading wires of the signal lines and those of the touch electrodes do not interfere with each other.

A touch display device is provided by the present disclosure, including the array electrode in some embodiments of the present disclosure.

A method for manufacturing an array substrate is provided by the present disclosure, including the following steps:
providing a base substrate; and
forming, on the base substrate, first metal signal lines and first touch electrodes, wherein the first touch electrodes are made of metal, and the first touch electrodes are arranged at a layer different from the first metal signal lines and are insulated with the first metal signal lines.

In some embodiments of the present disclosure, when the first metal signal line is a gate line, the method of manufacturing an array substrate includes the following steps:
Step S1: providing a base substrate;
Step S2: forming, on the base substrate, a pattern of a gate metal layer including a pattern of gate lines;
Step S3: forming a first gate insulation layer;
Step S4: forming a pattern of the first touch electrodes, where the first touch electrodes are parallel to the first metal signal lines, and each of the first touch electrodes is close to a corresponding first metal signal line;
Step S5: forming a second gate insulation layer;
Step S6: forming a pattern of an active layer, and
Step S7: forming a pattern of a source-drain metal layer, wherein the pattern of the source-drain metal layer includes patterns of data lines, source electrodes, drain electrodes and second touch electrodes.

The above are merely the preferred embodiments of the present disclosure. It should be noted that, a person skilled in the art may make further modifications and improvements without departing from the principle of the present disclosure, and these modifications and improvements shall also fall within the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An array substrate, comprising a base substrate and first metal signal lines and first touch electrodes arranged on the base substrate, wherein the first touch electrodes are made of metal and the first touch electrodes are arranged at a layer different from the first metal signal lines and are insulated with the first metal signal lines.

2. The array substrate according to claim 1, wherein the first touch electrodes are parallel to the first metal signal lines, and each of the first touch electrodes is close to a corresponding first metal signal line.

3. The array substrate according to claim 2, wherein an orthographic projection of each of the first touch electrodes onto the base substrate is not overlapped with an orthographic projection of the corresponding first metal signal line onto the base substrate.

4. The array substrate according to claim 3, wherein an edge of each of the first touch electrodes is aligned with an edge of an adjacent first metal signal line along an extending direction of the first touch electrode.

5. The array substrate according to claim 1, wherein the first metal signal line comprises gate lines, and the array substrate further comprises:
a first gate insulation layer, arranged on the gate lines; and
a second gate insulation layer, arranged on the first touch electrodes;
wherein the first touch electrodes are arranged between the first gate insulation layer and the second gate insulation layer.

6. The array substrate according to claim 1, wherein each of the first touch electrodes comprises a plurality of electrode wires, and the electrode wires in one first touch electrode are adjacent to and connected to each other.

7. The array substrate according to claim 1, wherein each of the first touch electrodes is a driving electrode or a sensing electrode.

8. The array substrate according to claim 7, further comprising second metal signal lines and second touch electrodes, wherein the first metal signal lines are gate lines, the second metal signal lines are data lines, and the second touch electrodes are arranged at a layer and made of a material identical to the data lines.

9. The array substrate according to claim 3, wherein each of the first touch electrodes and the corresponding first metal signal line are spaced from each other at a predetermined interval along a direction perpendicular to an extending direction of the first touch electrode.

10. The array substrate according to claim 9, wherein the predetermined interval is 1 μm.

11. The array substrate according to claim 8, wherein each of the second touch electrodes comprises a plurality of electrode wires, and the electrode wires in one second touch electrode are adjacent to and connected to each other.

12. A touch display device, comprising the array substrate according to claim 1.

13. A method of manufacturing an array substrate, comprising:
providing a base substrate; and
forming, on the base substrate, first metal signal lines and first touch electrodes, wherein the first touch electrodes are made of metal, and the first touch electrodes are arranged at a layer different from the first metal signal lines and are insulated with the first metal signal lines.

14. The method according to claim 13, wherein the first metal signal lines are gate lines, and the method of manufacturing an array substrate further comprises:
forming, on the base substrate, a pattern of a gate metal layer comprising a pattern of gate lines;
forming a first gate insulation layer;
forming a pattern of the first touch electrodes, wherein the first touch electrodes are parallel to the first metal signal lines, and each of the first touch electrodes is close to a corresponding first metal signal line;
forming a second gate insulation layer;
forming a pattern of an active layer; and
forming a pattern of a source-drain metal layer, wherein the pattern of the source-drain metal layer comprises patterns of data lines, source electrodes, drain electrodes and second touch electrodes.
